(19) United States
(12) Patent Application Publication
(10) Pub. No.: US 2026/0086317 A1
(43) Pub. Date: Mar. 26, 2026

(54) DISPLAY ADJUSTMENT FOR A HEAD-MOUNTABLE DISPLAY DEVICE

(71) Applicant: Apple Inc., Cupertino, CA (US)

(72) Inventors: Alexander B von Schulmann, Sunnyvale, CA (US); Trevor S Chambers, San Diego, CA (US); Matin Seadat Beheshti, Sunnyvale, CA (US)

(21) Appl. No.: 19/075,645

(22) Filed: Mar. 10, 2025

Related U.S. Application Data
(60) Provisional application No. 63/696,860, filed on Sep. 20, 2024.

(51) Int. Cl. G02B 7/12; G02B 27/01

(52) U.S. Cl. CPC G02B 7/12; G02B 27/0176; G02B 2027/0154

(57) ABSTRACT

A head-mountable display device can include a frame and a display with a first optical module and a second optical module that are offset from each other. The head-mountable display device further includes an interpupillary distance adjustment mechanism that adjust the distance between the first optical module and the second optical module to adjust the distance to be the same as the interpupillary distance of a user of the head-mountable device.

### CROSS-REFERENCE TO RELATED APPLICATIONS

This claims priority to U.S. Provisional Patent Application No. 63/696,860 , filed 20 Sep. 2024, and entitled “DISPLAY ADJUSTMENT FOR A HEAD-MOUNTABLE DISPLAY DEVICE,” the entire disclosure of which is hereby incorporated by reference.

### FIELD

The present disclosure relates generally to head-mountable display devices. More particularly, the present disclosure relates to adjusting an interpupillary distance of optical modules for a head-mountable display device.

### BACKGROUND

Recent advances in portable computing have led to an increase in the use of head-mounted display devices. Displays of the head-mountable devices can include one or more optical modules that present images to the user's eyes. Users of the head-mounted display devices can have unique interpupillary distances, or distances between the center of the user's two pupils. For optimal use of the head-mountable display device, a position of the pair of optical modules can be adjusted so that the optical modules are aligned with the user's interpupillary distance. Therefore, what is needed in the art is a head-mountable display device that includes an interpupillary distance adjustment mechanism that is capable adjusting the distance between the optical modules to optimize the use of the head-mountable display device for each user.

### SUMMARY

In at least one example, a head-mountable display device can include, a frame, a display coupled to the frame, the display including a first optical module and a second optical module, and an interpupillary distance adjustment mechanism configured to adjust a distance between the first optical module and the second optical module. The first optical module defines a first viewing plane and the second optical module defines a second viewing plane non-parallel to the first viewing plane.

In one example, the interpupillary distance adjustment mechanism is configured to simultaneously adjusts a first position of the first optical module and a second position of the second optical module either toward or away from each other. In one example, the interpupillary distance adjustment mechanism can include a central post, a first linear actuator coupled to the central post and the first optical module, and a second linear actuator coupled to the central post and the second optical module. The first optical module and the second optical module are offset from the central post and actuation of the first linear actuator and the second linear actuator adjusts a first position of the first optical module and a second position of the second optical module either toward or away from the central post. In one example, the interpupillary distance adjustment mechanism includes a rack-and-pinion assembly. The first linear actuator includes a first rack of the rack-and-pinion assembly, and the second linear actuator includes a second rack of the rack-and-pinion assembly, and a pinion of the rack-and-pinion assembly includes a circular gear disposed in the central post and engaging the first rack and the second rack. In one example, during actuation the first rack is free of engagement from the second rack. In one example, the first rack is configured to engage with an upper portion of the circular gear and the second rack is configured to engage with a lower portion of the circular gear. In one example, the circular gear includes a helical gear, the first rack is configured to engage with a bottom of the helical gear, and the second rack is configured to engage with a top of the helical gear so that the first rack is free of engagement from the second rack during the actuation. In one example, the central post can include a drive shaft including bevel gears at opposing ends of the drive shaft to offset the first linear actuator and the second linear actuator from the central post. In one example, the interpupillary distance adjustment mechanism is configured to be manually actuated by a user. In one example, a manual movement of at least one of the first optical module or the second optical module translates both the first optical module and the second optical module.

In at least one example, a head-mountable display device can include a frame, a display coupled to the frame and can include a first optical module and a second optical module, and an interpupillary distance adjustment mechanism configured to adjust a distance between the first optical module and the second optical module. The interpupillary distance adjustment mechanism can include a central post, a first pulley disposed on a first side of the central post, a second pulley disposed on a second side of the central post, and a cable looped through the first pulley, the central post, and the second pulley. The cable is coupled to the first optical module disposed between the first pulley and the central post and the cable is coupled to the second optical module disposed between the second pulley and the central post.

In one example, the head-mountable display device can further include a central pulley disposed with the central post and the cable is looped through the central pulley. In one example, the head-mountable display device can further include a guiding surface disposed within the central post and the cable is guided along the guiding surface. In one example, the head-mountable display device can further include a first cable coupled to the first optical module, the first cable extending through the first pulley, extending through the central post, and coupled to the second optical module and a second cable coupled to the second optical module, the second cable extending through the second pulley, extending through the central post, and coupled to the second optical module. In one example, the interpupillary distance adjustment mechanism is disposed near an upper portion of the frame. In one example, the first pulley and the second pulley each includes a pair of pulleys configured to vary a height of the cable as the cable loops through the pair of pulleys of the first pulley and the pair of pulleys of the second pulley. In one example, the first pulley is angled relative to the second pulley to vary a height of the cable as the cable loops through the first pulley and the second pulley. In one example, the interpupillary distance adjustment mechanism further includes a tensioning pulley configured to limit creep of the cable.

In at least one example, a head-mountable display device can include a frame, a display coupled to the frame, the display including a first optical module and a second optical module, and an interpupillary distance adjustment mechanism configured to adjust a distance between the first optical module and the second optical module. The interpupillary distance adjustment mechanism can include a first leadscrew coupled to the first optical module, a second leadscrew coupled to the second optical module and disposed at an angle relative to the first leadscrew, a center joint connecting the first leadscrew and the second leadscrew. A rotation of the first leadscrew or the second leadscrew adjust the interpupillary distance between the first optical module and the second optical module.

In one example, the adjustment of the first leadscrew simultaneously adjusts a position of the second optical module.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective schematic view of an example of a head-mountable display device;

FIG. 2 shows rear schematic view of an example of a head-mountable display device including an interpupillary distance adjustment mechanism;

FIG. 3 shows a top schematic view an example of a head-mountable display device including an interpupillary distance adjustment mechanism;

FIG. 4 shows an example of a mechanism for an interpupillary distance adjustment mechanism;

FIG. 5 shows an example of a mechanism for an interpupillary distance adjustment mechanism;

FIG. 6 shows an example of a mechanism for an interpupillary distance adjustment mechanism;

FIG. 7A shows an example of a mechanism for an interpupillary distance adjustment mechanism;

FIG. 7B shows a rear schematic view of the interpupillary distance adjustment mechanism of FIG. 7A.

FIG. 8A shows a rear schematic view of an example of a head-mountable display device including an interpupillary distance adjustment mechanism;

FIG. 8B shows a top schematic view of the interpupillary distance adjustment mechanism of FIG. 8A;

FIG. 8C shows a top schematic view of an example of an interpupillary distance adjustment mechanism;

FIG. 8D shows a top schematic view of an example of an interpupillary distance adjustment mechanism;

FIG. 9A shows a rear schematic view of an example of an interpupillary distance adjustment mechanism; and

FIG. 9B shows a rear schematic view of an example of an interpupillary distance adjustment mechanism.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

The following disclosure relates to display portions for head-mountable display devices. The display portion can include a right optical module for a right eye of a user and a left optical module for a left eye of the user. For ergonomic purposes, the right optical module and the left optical module can be offset from each other so that the display portion of the head-mountable device contours to the shape of a user's face. In other words, the right optical module and the left optical module can be non-co-planar.

The optical modules of the head-mountable display device can be a screen. In some examples, the optical modules can be an organic light-emitting diode (OLED) screen, a light-emitting diode (LED) screen, a liquid crystal display (LCD) screen, or another type of screen. In at least one example, the optical modules can include non-corrective lenses, transparent windows, or reflective materials. In some examples, light from the optical modules can travel through a lens before being perceived by a user. In this manner, the optical modules can facilitate a desirable user experience by producing high-quality, engaging, and clear media for a user to perceive.

Each user of the head-mountable display device can have a different interpupillary distance (“IPD”). IPD is the distance between the centers of the pupils of the user. The average IPD for adults is between 50-70 mm, with an average around 63 mm. The average IPD for children is 43-58 mm. To accommodate users with different IPDs, the optical modules can be adjusted by an IPD adjustment mechanism. The IPD adjustment mechanism can be configured to adjust the optical modules to match the IPD of the user. The optical modules can be move independently or simultaneously by the IPD adjustment mechanism in either a co-planar or non-planar configuration.

The optical modules and adjustment mechanisms of head-mountable display devices described herein can include cables, rods, pulleys, and/or gears configured to move optical modules simultaneously and accurately. The simultaneous adjustment of optical modules can ensure each module is appropriately positioned and the user only needs to adjust one optical module in order to automatically adjust the other. This prevents the user from having to independently adjust two optical modules, which would lead to increased chances of adjustment errors and more time and effort required for IPD adjustments. In addition, the adjustment mechanisms described herein can adjust displays along non-parallel and/or non-colinear paths such that a head-mountable device curved to conform to a human face can accommodate two displays being adjusted along the same curvature.

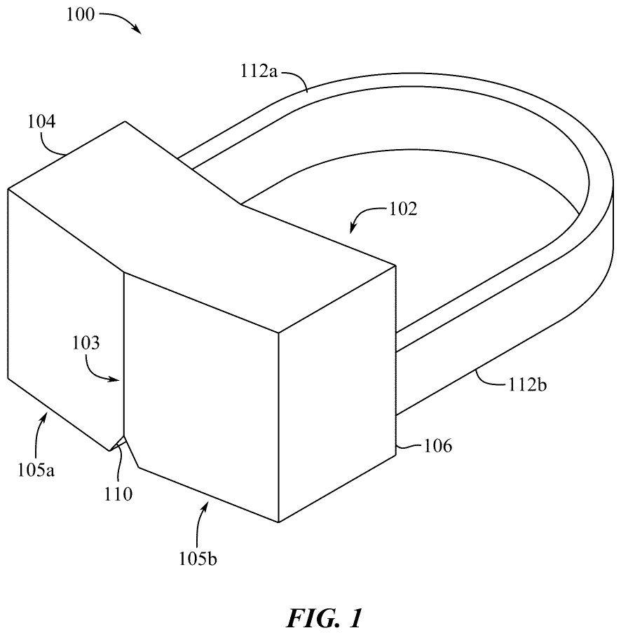

These and other examples are discussed below with reference to FIGS. 1-9B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a perspective view of a head-mountable display device (HMD) 100. In some examples, the head-mountable display device 100 can be a head-mountable device configured to display media to a user. The head-mountable display device 100 can include a display portion 102, a frame 104, a facial interface 106, and one or more securement arms 112a-b coupled to the frame 104. The head-mountable display device 100 can be configured to be mounted to the head of a user and to display visual media to the user. In some examples, the visual media displayed by the head-mountable display device 100 can include videos, live streams, websites, recordings, virtual reality settings, television, or other forms of visual media. In some examples, the securement arms 112a-b can be configured to rest on the ears of a user. The securement arms 112a-b can be configured to support at least a portion of the weight of the head-mountable display device 100. The head-mountable display device 100 can, in some examples, also include a nose piece 110. The nose piece 110 can include a nose bridge configured to conform to the shape of the nose such that the nose piece 110 can rest on the nose of a user and at least partially support the head-mountable display device 100. The head-mountable display device 100 can be configured to provide a comfortable user experience by utilizing a variety of polymers, ceramics, metals, or composite materials. In some examples, the materials used to construct the head-mountable display device 100 can include silicone, foam, fabric, aluminum, steel, plastics, and/or other materials.

In some examples, the head-mountable display device 100 can include various electrical and electronic components. For example, the head-mountable display device 100 can include one or more processors, speakers, batteries, screens, projectors, motors, linear actuators, cameras, sensors, wires, and other components. The various electrical and electronic components can be disposed within various parts of the head-mountable display device 100. For example, at least one of the securement arms 112a-b can include a battery and/or a speaker. The display portion 102 can include a processor, camera, and screen. The electronic components disposed in the securement arms 112a-b can be electrically coupled to the electronic components disposed within the display portion 102. The electrical and electronic components included in the head-mountable display device 100 can produce an immersive and desirable user experience.

The nose piece 110 can also include a padded portion or a contoured portion. In some examples, at least the nose piece 110 can be a combination of padded and contoured portions.

Due to the contour of the user's face, the frame 104 can be angled to correspond to the contour of the user's face. For example, as illustrated, a first lateral side 105a of the frame 104 can be angled toward a center or apex 103 and a second lateral side 105b of the frame 104 can be angled toward the center or apex 103. The apex 103 can be horizontally aligned with the nose piece 110. Accordingly, the first lateral side 105a and the second lateral side 105b are not co-planar. While the example of FIG. 1 shows an abrupt change in angle at the apex 103, this can be a simplified, non-limiting example of a curvature of the device 100. Other examples of the device 100 can include a rounded, continuously curved surface or surfaces.

The frame 104, however, can be designed in a variety of different manners. For example, the frame 104 can be curved from a first lateral end of the frame 104 to a second lateral side 105b of the frame 104. The curve can have a constant radius, or the curve can be a complex curve with a radius of curvature that changes through the curve.

In at least one example, the facial interface 106 of the device 100 can extend toward the user's head and face from the display portion 102 and/or frame 104 thereof to ensure certain other components of the device 100 maintain an appropriate and comfortable distance relative to the user's face, for example the user's eyes, during operation. For example, the display portion 102 can include one or more display screens and/or lenses, which will be shown in other figures and described in more detail below, which can be aligned with the user's eyes for displaying information thereto.

Any of the features, components, and/or parts, including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

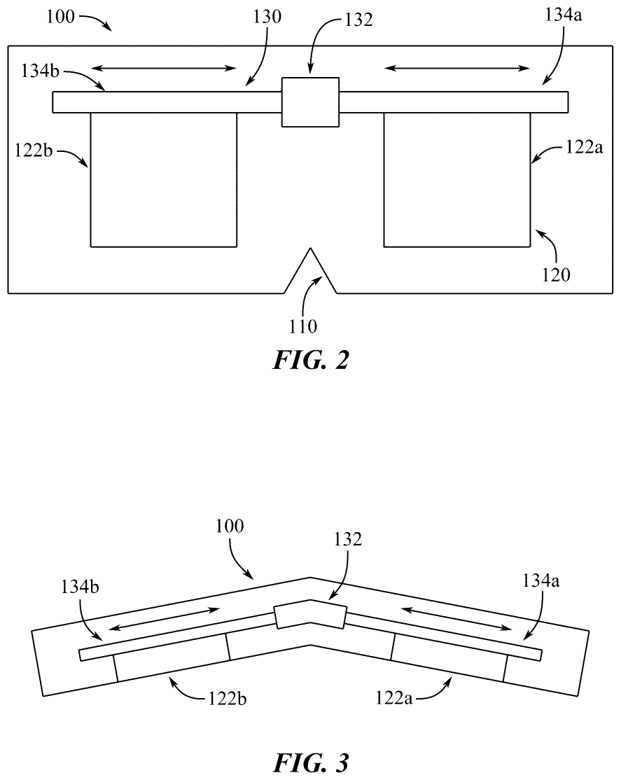

FIG. 2 illustrates a rear schematic view of the head-mountable display device 100. FIG. 3 shows a top schematic view of the head mountable display device. The head-mountable display device 100 can include a display 120 with a plurality of optical modules 122 that present images to the user's eyes. In the illustrated example, the display 120 includes a pair of optical modules 122a, 122b, a right optical module 122a for a right eye and a left optical module 122b for a left eye. The right optical module 122a defines a first viewing plane and the left optical module 122b defines a second viewing plane. The right optical module 122a and the left optical module 122b can be angled at a non-zero angle with respect to each other to help guide the optical modules 122a, 122b parallel to the surface of the user's face. In other words, the optical modules 122a, 122b are non-parallel, offset, and are not co-planar. Each optical module 122 can have a lens barrel with a display and a lens that present an image from the display to a corresponding eye.

The optical modules 122 can be or can include a screen. In some examples, the optical modules 122 can each be an OLED screen, an LED screen, an LCD screen, or another type of screen. In other examples, the optical modules can be or can include a surface onto which an image is projected. In some examples, the optical modules can include transparent windows or lenses, corrective lenses, and so forth. In some examples, light from the optical modules 122 can travel through the lens before being perceived by a user. The lens can be configured to change a characteristic of the light from the optical modules 122a and 122b. For example, the lens can be configured to magnify or focus the media produced at the optical modules 122a and 122b. In other examples, the lens can be configured to change some portions of the media produced at the optical modules 122a and 122b. For example, the lens can change the proportions of the media produced at the optical modules 122. In this manner, the lens and the optical modules can facilitate a desirable user experience by producing high-quality, engaging, and clear media for a user to perceive.

To accommodate users with different interpupillary distances, the optical modules 122a and 122b of the display 120 can be adjusted by an IPD adjustment mechanism 130. The IPD adjustment mechanism 130 can include a central post 132 that is secured to the frame 104. The central post 132 can be secured to the frame 104 by fasteners, such as screws and the like. The central post 132 can be horizontally aligned with the nose piece 110.

In one example, guide members such as guide rods 134 can be slidably coupled to the central post 132. Actuators can slide the optical modules 122a and 122b towards or away from each other along the guide rods, thereby accommodating different interpupillary distances as illustrated by arrows. Various actuators will be described in detail below. The actuators can be actuated manually or by a motor.

The guide rods 134 can extend horizontally across the head-mountable display device 100. The guide rods 134 can be formed from fiber-reinforced composite tubes with one or more end caps that are fastened to the frame 104 in the head-mounted display device 100. A common end cap can, if desired, be used to join a pair of guide rods 134. End caps can be formed as separate pieces attached to the ends of the fiber composite tubes or other guide rod 134 structures and/or can be integral portions of the fiber composite tubes or other guide rod 134 structures.

The guide rods 134 can include a right guide rod 134a slidably engaged with the right optical module 122a and a left guide rod 134b slidably engaged with the left optical module 122b. Left and right guide rods 134a, 134b can be angled at a non-zero angle with respect to each other to help guide the optical modules parallel to the surface of a user's face. In other words, the guide rods 134a, 134b are non-parallel, offset, and are not co-planar.

The tubes of the guide rods 134a, 134b can be partly or completely filled with cores or other support structures and features to add strength. Low-friction coatings, such as metal coatings, can be applied to the tubes and on corresponding inner surfaces of the optical module structures that receive the tubes.

The guide rods 134a and 134b can have circular cross-sectional shapes or can have other suitable cross-sectional shape. The portions of optical modules 122 that receive guide rods 134a and 134b can have corresponding mating shapes (e.g., full or partial circular openings with inner diameters corresponding to the outer diameters of guide rods 134a and 134b). To prevent sticking, the inner surfaces of the optical module guide rod openings and/or the outer surfaces of guide rods 134a and 134b can be provided with low stick surfaces (e.g., using low-stick coatings, lubricant such as grease, etc.).

Any of the features, components, and/or parts, including the arrangements and configurations thereof shown in FIGS. 2 and 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2 and 3.

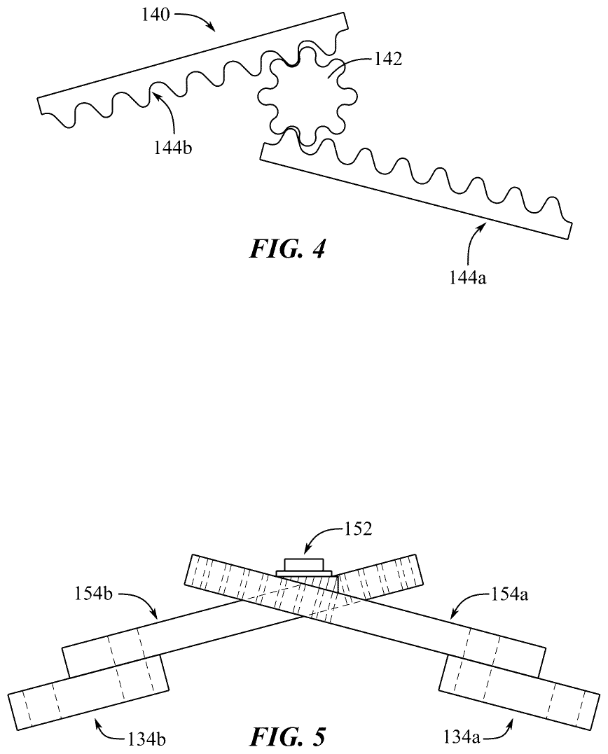

FIG. 4 shows an example of a mechanism 140 for the IPD adjustment mechanism 130. The mechanism 140 can include a rack-and-pinion as part of a linear actuator that includes a toothed circular gear 142 (e.g., the pinion) and a pair of linear gears 144a, 144b (e.g., the racks). The circular gear 142 can be disposed in the central post 132 of the IPD adjustment mechanism 130. The linear gear 144a can be disposed on a right side of the IPD adjustment mechanism 130 and the linear gear 144b can be disposed on a left side of the IPD adjustment mechanism 130. The circular gear 142 can be sized sufficiently so that the linear gears 144a, 144b are free of engagement and do not engage with each other during actuation. For example, the linear gear 144a can engage with an upper portion of the circular gear 142 and the linear gear 144b can engage with a lower portion of the circular gear 142, or vice versa. In other words, one of the linear gears 144a, 144b engages the circular gear 142 above the other linear gear 144a, 144b. As illustrated, the linear gears 144a, 144b are not co-planar and can be non-parallel and offset from each other. In some examples, the linear gears 144a, 144b are offset by at least about 5-degrees to accommodate the curvature of the device 100 as the IPD adjustment mechanism 130 is disposed within the device 100. Other examples can include linear gears 144a-b offset by more or less than 5-degrees depending on the curvature of the device 100.

The linear gears 144a, 144b are each coupled to a corresponding guide rod 134a, 134b. The right linear gear 144a is coupled to the right guide rod 134a and the left linear gear 144b is coupled to the left guide rod 134b. The mechanism 140 can be actuated in a number of different ways. For example, the mechanism 140 can be manually actuated by a user or can be actuated by a motor. The user can press a button to rotate the circular gear 142 or rotate a dial to rotate the circular gear 142. As the circular gear 142 is rotated, the guide rods 134a, 134b either move toward or move away the central post 132 to adjust the IPD distance for the user. In this manner, the optical modules 122a, 122b move toward or away from each other. In other words, the optical module 122a, 122b move from a first position to a second position. In some examples, the user can grip the optical modules 122a, 122b and translate them towards or away from the central post 132. In some examples, the movement of the optical modules 122a, 122b is simultaneous, so the user can also only move one of the optical modules 122a or 122b and the other optical module 122a or 122b would move an equal amount either toward or away from the central post 132 and the other optical module 122a or 122b.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 shows an example of a mechanism 150 for the IPD adjustment mechanism 130. The mechanism 150 can include a rack-and-pinion forming a linear actuator that includes a helical gear 152 (e.g., the pinion) and a pair of linear gears 154a, 154b (e.g., the racks). The helical gear 152 can be disposed in the central post 132 of the IPD adjustment mechanism 130. The linear gear 154a can be disposed on a right side of the IPD adjustment mechanism 130 and the linear gear 154b can be disposed on a left side of the IPD adjustment mechanism 130. The helical gear 152 can be sized sufficiently so that the linear gears 154a, 154b are free of engagement and do not engage with each other during actuation. For example, the linear gear 154a can engage with a top of the helical gear 152 and the linear gear 154b can engage with a bottom of the helical gear 152, or vice versa. As illustrated, the linear gears 154a, 154b are not co-planar and can be non-parallel and offset from each other. In some examples, the linear gears 154a, 154b are offset by approximately 5 degrees.

The linear gears 154a, 154b can each be coupled to a corresponding guide rod 134a, 134b. The right linear gear 154a is coupled to the right guide rod 134a and the left linear gear 154b is coupled to the left guide rod 134b. The mechanism 150 can be actuated in a number of different ways. For example, the mechanism 150 can be manually actuated by a user or it can be actuated by a motor. The user can press a button to rotate the helical gear 152 or can rotate a dial to rotate the helical gear 152. As the helical gear 152 is rotated, the guide rods 134a, 134b either move toward or move away the central post 132 to adjust the IPD distance for the user. In this manner, the optical modules 122a, 122b can move toward or away from each other. In other words, the optical modules 122a, 122b move from a first position to a second position. In some examples, the user can grip the optical modules 122a, 122b and move them towards or away from the central post 132 and each other. In some examples, the movement of the optical modules 122a, 122b is simultaneous, so the user can also move only one of the optical modules 122a or 122b and the other optical module 122a or 122b would move an equal amount either toward or away from central post 132 and the other optical module 122a or 122b.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

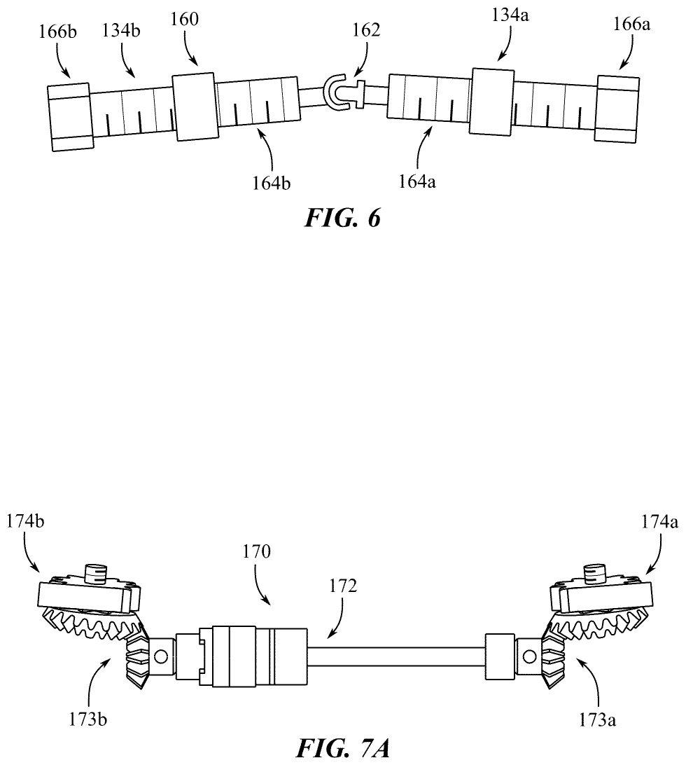

FIG. 6 shows an example of a mechanism 160 for the IPD adjustment mechanism 130. The mechanism 160 is a leadscrew that includes a center joint 162, a pair of screws 164a, 164b coupled together at the center joint 162, and a pair of bearings 166a, 166b. The center joint 162 can be disposed in the central post 132 of the IPD adjustment mechanism 130. The center joint 162 can be a universal coupling, a solid joint, bevel gears (including an idler pulley), a flexible shaft, and the like.

A first screw 164a can be disposed on a right side of the IPD adjustment mechanism 130 and a second screw 164b can be disposed on a left side of the IPD adjustment mechanism 130. The screws 164a, 164b can be a back-drivable, multi-start leadscrew. As illustrated, the screws 164a, 164b are not co-planar and can be non-parallel and offset from each other. In some examples, the screws 164a, 164b are offset by at least about 5-degrees or more to accommodate the general curvature of the device 100 and the human face.

A first bearing 166a, such as a ball bearing, can be disposed at an opposite end of the screw 164a from the center joint 162. A second bearing 166b, such as a ball bearing, can be disposed at an opposite end of the screw 164b from the center joint 162. The bearings 166a, 166b can be rotated, which allows for simultaneous rotation of the screws 164a, 164b.

Each screw 164a, 164b can be coupled to a corresponding guide rod 134a, 134b. The right screw 164a is coupled to the right guide rod 134a and the left screw 164b is coupled to the left guide rod 134b. The mechanism 160 can be actuated in a number of different ways. For example, the mechanism 160 can be manually actuated by a user or can actuated by a motor. The user can press a button to rotate the screws 164a, 164b relative to the bearings 166a, 166b or rotate a dial to manually rotate the screws 164a, 164b relative to the bearings 166a, 166b. As the screws 164a, 164b are rotated relative to the ball bearings 166a, 166b, the guide rods 134a, 134b either move toward or move away from the center joint 162 and each other to adjust the IPD distance for the user. In some examples, the user can grip the optical modules (not shown) and move them towards or away from the center joint 162 and each other. In some examples, the movement of the guide rods 134a, 134b and their corresponding optical modules is simultaneous, so the user can also move only one of the optical modules or guide rods and the other optical module or guide rod would move an equal amount either toward or away from the center joint 162 and the other guide rod 134a or 134b and their corresponding optical module. In other words, the optical modules shown as 122a, 122b in FIG. 2 can be moved from a first position to a second position.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

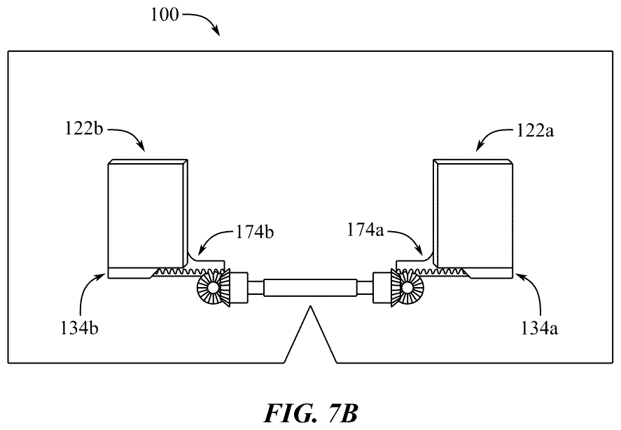

FIG. 7A shows an example of a mechanism 170 that can serve as the IPD adjustment mechanism 130 in FIG. 2. The mechanism 170 is a rack-and-pinion system forming a linear actuator that includes a drive shaft 172 with bevel gears 173a, 173b (e.g., the pinion) and a pair of linear gears 174a, 174b (e.g., the racks). The drive shaft 172 can be disposed through the central post 132 of the IPD adjustment mechanism 130 shown in FIG. 2. The linear gear 174a can be disposed on a right side of the IPD adjustment mechanism 130 and the linear gear 174b can be disposed on a left side of the IPD adjustment mechanism 130. A right end of the drive shaft 172 can include bevel gears 173a that mesh with the linear gear 174a and a left end of the drive shaft 172 can include bevel gears 173b that mesh with the linear gear 174b. Bevel gears 173a, 173b can be disposed on opposing ends of the drive shaft. As illustrated, the linear gears 174a, 174b can be non-coplanar and can be non-parallel offset from each other by the bevel gears 173a, 173b. In some examples, the linear gears 174a, 174b are offset by at least about 5-degrees to accommodate the curvature of the device 100 and the human face.

As illustrated in FIG. 7B, the linear gears 174a, 174b can each be coupled to a corresponding guide rod 134a, 134b. The right linear gear 174a can be coupled to the right guide rod 134a and the left linear gear 174b can be coupled to the left guide rod 134b. The mechanism 170 can be actuated in a number of different ways. For example, the mechanism 170 can be manually actuated by a user or it can be actuated by a motor. The user can press a button to rotate the drive shaft 172 or rotate a dial to rotate the drive shaft 172. As the drive shaft 172 is rotated, the guide rods 134a, 134b either move toward or away from the central portion of the drive shaft 172 and each other to adjust the IPD distance for the user. In some examples, the user can grip the optical modules 122a, 122b and move them towards each other or away from the central portion of the drive shaft 172 and each other. In some examples, the movement of the optical modules 122a, 122b is simultaneous, so the user can also move only one of the optical modules 122a or 122b and the other optical module 122a or 122b would move an equal amount either toward or away from the other optical module 122a or 122b. In other words, the optical modules 122a, 122b can each move from a first position to a second position.

Any of the features, components, and/or parts, including the arrangements and configurations thereof shown in FIGS. 7A-7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7A-7B.

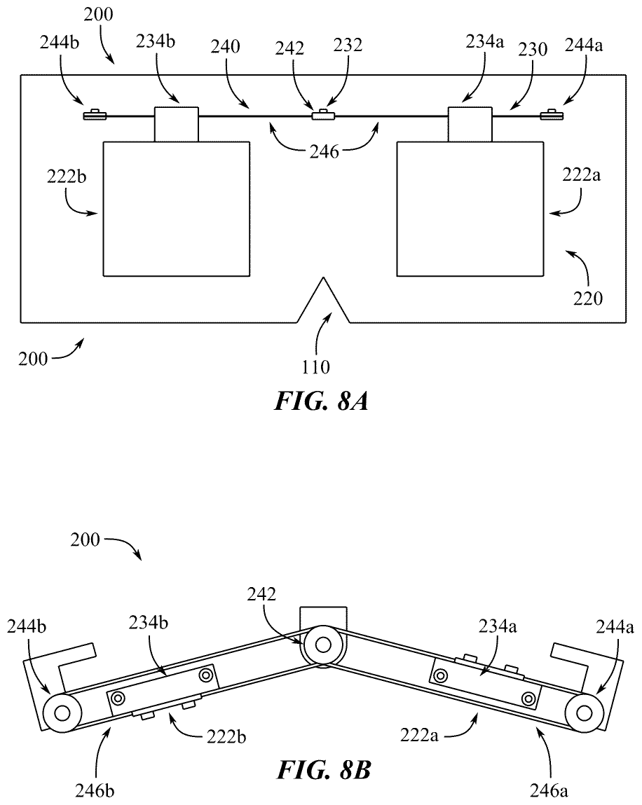

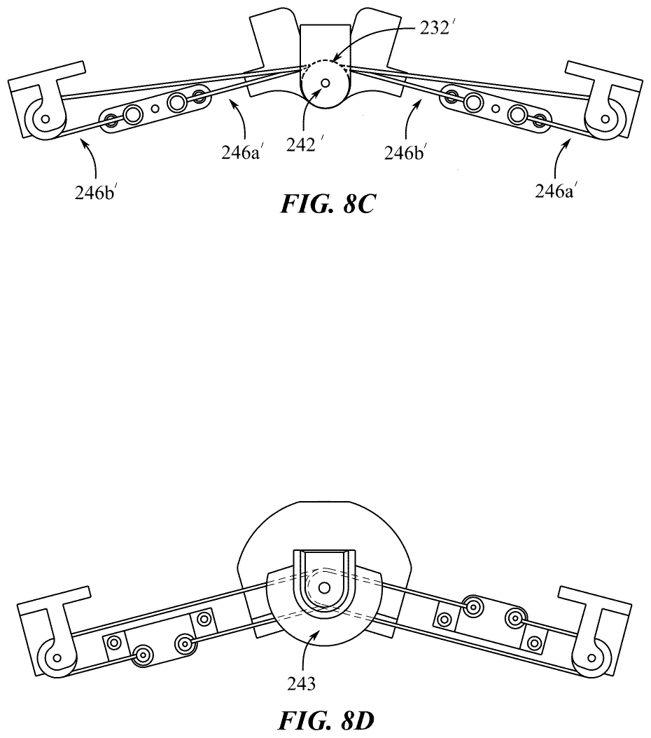

FIG. 8A shows a rear schematic view of the head-mountable display device 200. FIG. 8B shows a top schematic view of the head mountable display device 200. The head-mountable display device 200 can include a display 220 with a plurality of optical modules 222a, 222b that present images to the user's eyes. In the illustrated example, the display 220 includes a pair of optical modules 222a, 222b, a right optical module 222a for a right eye and a left optical module 222b for a left eye. Each optical module 222 can have a lens barrel with a display and a lens that present an image from the display to a corresponding eye.

To accommodate users with different interpupillary distances, the optical modules 222 can be adjusted by an IPD adjustment mechanism 230. The IPD adjustment mechanism 230 can include a central post 232 that is secured to a frame 204.

Guide members such as cable attachments 234a, 234b can be slidably coupled to the central post 232. Actuators can translate the optical modules 222 towards or away from each other via the cable attachments 234a, 234b, thereby accommodating different interpupillary distances. The cable attachments 234a, 234b can be connected to cables 246. The cable attachments 234a, 234b can include a right cable attachment 234a connected the right optical module 222a and a left cable attachment 234b connected to the left optical module 222b. Left and right cable attachments 234a, 234b can be angled at a non-zero angle with respect to each other to help guide the optical modules 222a, 222b parallel to the surface of a user's face. In other words, the cable attachments 234a, 234b can be non-co-planar.

The IPD adjustment mechanism 230 can include a mechanism 240 for adjusting the IPD the head-mountable display device 200. In the illustrated example, the mechanism 240 can be disposed near a top of the head-mountable display device 200. The mechanism 240 can be a pulley system that uses pulleys and a cable 246 that is looped through the pulleys while maintaining the cable in constant tension. In some examples, there can be more than one cable. In the illustrated example, the mechanism 240 includes a central pulley 242, a pair of idler pulleys 244a, 244b, and a pair of cables 246a, 246b. The central pulley 242 can be disposed in or on the central post 232 of the IPD adjustment mechanism 230. The idler pulley 244a can be disposed on the right side and the idler pulley 244b can be disposed on the left side.

In some examples, the central pulley 242 can be a low friction guiding surface. FIG. 8C shows a guiding surface 242′ that can be disposed in the central post 232′ of the IPD adjustment mechanism 230′. The guiding surface 242′ can be a low friction guiding surface to reduce the friction the cables 246a′, 246b′ encounter in their interaction with the guiding surface 242′.

As illustrated in FIG. 8B, a first cable 246a can be coupled to the right cable attachment 234a, can extend to and loop through the idler pulley 244a, extend to and loop through the central pulley 242, and extend and couple again to the right cable attachment 234a. The second cable 246b can be coupled to the left cable attachment 234b, extend to and loop through the idler pulley 244b, extend to and loop through the central pulley 242, and extend and couple again to the left cable attachment 234b, as illustrated in FIG. 8B. The right cable attachment 234b is disposed closer to the rear of the head-mountable display device 200 and the left cable attachment 234a is disposed closer to the front of the head-mountable display device 200. As illustrated, the optical modules 222a, 222b are not co-planar and can be non-parallel offset from each other. In some examples, the optical modules 222a, 222b can be offset by approximately 5 degrees.

The mechanism 240 can be actuated in a number of different ways. For example, the mechanism 240 can be manually actuated by a user or can by actuated by a motor. The user can press a button to rotate the central pulley 242. As the central pulley 242 is rotated, the cables 246a, 246b are translated which translates the cable attachments 234a, 234b and the optical modules 222a, 222b either move toward or move away from the central post 232 and each other to adjust the IPD distance for the user. In some examples, the user can grip the optical modules 222a, 222b and move them towards or away from the central post 232 and each other. In some examples, the movement of the optical modules 222a, 222b is simultaneous or coordinated, so the user can also move only one of the optical modules 222a or 222b and the other optical module 222a or 222b would move an equal amount either toward or away from the central post 232 and the other optical module 222a or 222b as they are both tied to the central pulley, though in some examples the cables 246a, 246b are disposed in different pulley channels on the central pulley and are simultaneously translated when the central pulley 242 is rotated. In other words, each optical module 222a, 222b move from a first position to a second position. FIG. 8D illustrates a dial 243 that a user can rotate to rotate the central pulley 242 to adjust the IPD distance for the user.

In some examples, the IPD adjustment mechanism 330 can further include a tensioner or a tensioning pulley to help to limit creep in the cables 246a, 246b. In some examples, the cables 246a, 246b can include timing belts.

FIG. 8C illustrates an IPD adjustment mechanism 230 including a first friction cable 246a′ and a second friction cable 246b′ each connected to opposite ends of each cable attachment. In this way, rather than each friction cable 246a′, 246b′ operating in a separate closed loop and coordinating movement through a common central pulley 242, the friction cables are connected in series through the idler pulleys and the central pulley 242′ connected to the central post 232′ such that translation of one cable attachment is coordinated or mirrored by the other cable attachment.

Any of the features, components, and/or parts, including the arrangements and configurations thereof shown in FIGS. 8A-8D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8A-8D.

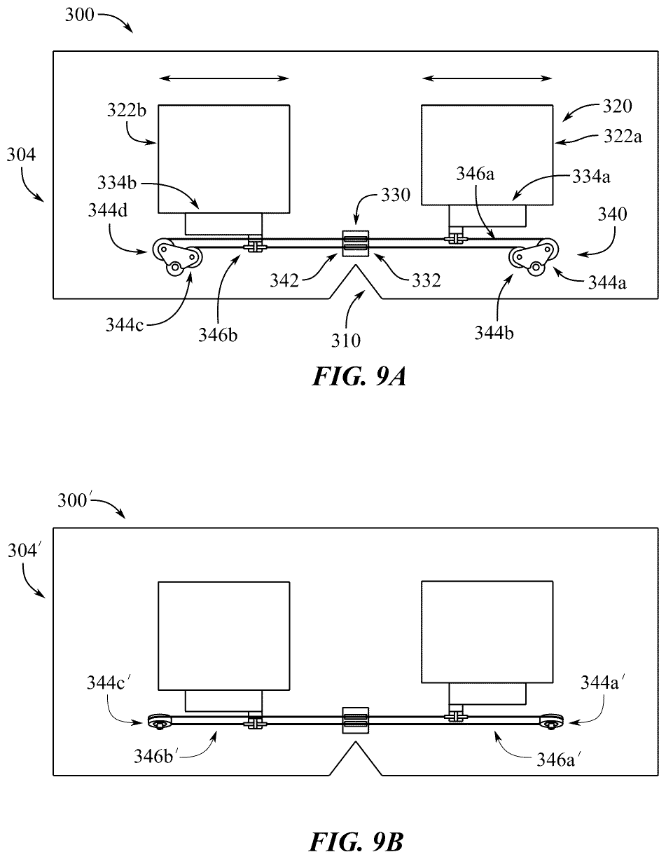

FIG. 9A shows a rear schematic view of the head mountable display device 300. The head-mountable display device 300 can include a display 320 with a plurality of optical modules 322 configured to present images to the user's eyes. In the illustrated example, the display 320 includes a pair of optical modules 322a, 322b, a right optical module 322a for a right eye and a left optical module 322b for a left eye. Each optical module 322 can have a display and a lens that present an image from the display to a corresponding eye.

To accommodate users with different interpupillary distances, the optical modules 322 can be adjusted by an IPD adjustment mechanism 330. The IPD adjustment mechanism 330 can include a central post 332 that is secured to a frame 304.

The optical modules 322a, 322b can each include a cable attachment 334a, 334b that can be slidably coupled to the central post 332 via a number of cables 346a, 346b. Actuators can translate the cables 346a, 346b to translate the the optical modules 322 towards or away from each other via the cable attachments 334a, 334b, thereby accommodating different interpupillary distance as illustrated by arrows. The cable attachments 334a, 334b can be connected to the cables 346a, 346b via any number of fastening systems and methods such as fasteners, adhesives, interference fits, and the like. The cable attachments 334a, 334b can include a right cable attachment 334a connected to the right optical module 322a and a left cable attachment 334b connected to the left optical module 322b. Left and right cable attachments 334a, 334b can be angled at a non-zero angle with respect to each other to help guide the optical modules 322a, 322b parallel to the surface of a user's face. In other words, the cable attachments 334a, 334b can be non-coplanar.

The IPD adjustment mechanism 330 can include a mechanism 340 for adjusting the IPD the head-mountable display device 300. In the illustrated example, the mechanism 340 can be disposed near a bottom of the head-mountable display device 300 near a nose piece 310. The mechanism 340 can be a pulley system that uses pulleys and cables that are in constant tension. In the illustrated example, the mechanism 340 includes a pair of central pulleys 342, a plurality of idler pulleys 344a, 344b, 344c, 344d, and a pair of cables 346a, 346b. The pair of central pulleys 342 can be disposed in the central post 332 of the IPD adjustment mechanism 330. A pair of idler pulleys 344a, 344b can be disposed on the right side and a pair of idler pulleys 344c, 344d can be disposed on the left side. Each pair of idler pulleys 344a, 344b, 344c, 344d are designed to help guide the pair of cables 346a, 346b so that the pair of cables 346a, 346b do not interfere with each other. Further, each pair of idler pulleys 344a, 344b, 344c, 344d are designed to vary the relative height of the cables 346a, 346b so that the cables 346a, 346b do not interfere with each other and that the space within the frame 304 of the head-mountable display device 300 is efficiently used as the frame 304 houses a plurality of electronic components for the head-mountable display device 300.

In another example illustrated in FIG. 9B, instead of a pair of idler pulleys disposed on a left side and a right side of a frame 304′ of a head-mountable display device 300′, the right side includes a single idler pulley 344a′ and the left side includes a single idler pulley 344c′. The idler pulleys 344a′, 344c′ are angled relative to each other. The angled idler pulleys 344a′, 344c′ are designed to help guide the pair of cables 346a′, 346b′ so that the pair of cables 346a, 346b do not interfere with each other. Further, the angle of each of the idler pulleys 344a′, 344c′ is designed to adjust the relative height of the cables 346a′, 346b′ so that the cables 346a′, 346b′ do not interfere with each other and the space within the frame 304′ of the head-mountable display device 300′ is efficiently used as the frame 304′ houses a plurality of electronic components for the head-mountable display device 300′.

As illustrated in FIG. 9A, a first cable 346a can be coupled to the right cable attachment 334a, extend to and loop through the pair of idler pulleys 344a, 344b, extend to and loop through one of the pair of central pulleys 342, and extend and couple to the left cable attachment 334b. The second cable 346b can be coupled to the left cable attachment 334b, extend to and loop through the pair of idler pulleys 344c, 344d, extend to and loop through the one of the pair of central pulleys 342, and extend and couple to the right cable attachment 334a. In one example, the right cable attachment 334a can be disposed closer to the front of the head-mountable display device 300 and the left cable attachment 334a can be disposed closer to the rear of the head-mountable display device 300. As illustrated, the optical modules 322a, 322b are not co-planar and can be non-parallel offset from each other. In some examples, the optical modules 322a, 322b are offset by 5 degrees. While the present system is illustrated with the optical modules 322a, 322b connected to and riding on the cables 346a, 346b, the optical modules can also be supported or translated along any number of additional structural supports or guides, such as guide rods (not shown).

The mechanism 340 can be actuated in a number of different ways. For example, the mechanism 340 can be manually actuated by a user or it can be actuated by a motor. The user can press a button to rotate the pair of central pulleys 342. As the pair of central pulleys 343 are rotated, the cables 346a, 346b are translated which translates the cable attachments 334a, 334b and the optical modules 322a, 322b either move toward each other or move away from each other to adjust the IPD distance for the user. In some examples, the user can grip the optical modules 322a, 322b and manually move them towards each other or away from each other. The movement of the optical modules 322a, 322b can be coordinated and/or simultaneous, so the user can also move only one of the optical modules 322a or 322b and the other optical module 322a or 322b would move an equal amount either toward or away from the other optical module 322a or 322b. In other words, each of the optical modules 322a, 322b move from a first position to a second position.

Any of the features, components, and/or parts, including the arrangements and configurations thereof shown in FIGS. 9A-9B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 9A-9B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. A head-mountable display device, comprising:
a frame;
a display coupled to the frame, the display comprising a first optical module and a second optical module; and
an interpupillary distance adjustment mechanism configured to adjust a distance between the first optical module and the second optical module;
wherein the first optical module defines a first viewing plane and the second optical module defines a second viewing plane non-parallel to the first viewing plane.

2. The head-mountable display device of claim 1, wherein the interpupillary distance adjustment mechanism is configured to simultaneously adjust a position of the first optical module and a position of the second optical module relative to each other.

3. The head-mountable display device of claim 1, wherein the interpupillary distance adjustment mechanism comprises:
a central post;
a first linear actuator coupled to the central post and the first optical module; and
a second linear actuator coupled to the central post and the second optical module;
wherein:
the first optical module and the second optical module are offset from the central post; and
actuation of the first linear actuator and the second linear actuator adjusts a position of both the first optical module and the second optical module toward or away from the central post.

4. The head-mountable display device of claim 3, wherein:
the first linear actuator comprises a first rack of a rack-and-pinion assembly;
the second linear actuator comprises a second rack of the rack-and-pinion assembly; and
the interpupillary distance adjustment mechanism further comprises a circular gear disposed in the central post and engaging the first rack and the second rack.

5. The head-mountable display device of claim 4, wherein during actuation the first rack is free of engagement from the second rack.

6. The head-mountable display device of claim 5, wherein:
the first rack is configured to engage with an upper portion of the circular gear; and
the second rack is configured to engage with a lower portion of the circular gear.

7. The head-mountable display device of claim 4, wherein:
the circular gear comprises a helical gear;
the first rack is configured to engage with a bottom of the helical gear; and
the second rack is configured to engage with a top of the helical gear so that the first rack is free of engagement from the second rack during the actuation.

8. The head-mountable display device of claim 3, wherein the central post comprises a drive shaft including bevel gears at opposing ends of the drive shaft to offset the first linear actuator and the second linear actuator from the central post.

9. The head-mountable display device of claim 1, wherein the interpupillary distance adjustment mechanism is configured to be manually actuated by a user.

10. The head-mountable display device of claim 1, wherein a manual movement of the first optical module translates both the first optical module and the second optical module.

11. A head-mountable display device, comprising:
a frame;
a display coupled to the frame and comprising a first optical module and a second optical module; and
an interpupillary distance adjustment mechanism configured to adjust a distance between the first optical module and the second optical module, the interpupillary distance adjustment mechanism comprising:
a central post;
a first pulley disposed on a first side of the central post;
a second pulley disposed on a second side of the central post;
a first cable connected to the first optical module, looped through the first pulley, and looped through the central post; and
a second cable connected to the second optical module, looped through the second pulley, and looped through the central post.

12. The head-mountable display device of claim 11, further comprising a central pulley disposed with the central post, wherein the first cable is looped through the central pulley, and the second cable is looped through the central pulley.

13. The head-mountable display device of claim 11, further comprising a guiding surface disposed within the central post, wherein the first cable engages the guiding surface, and the second cable engages the guiding surface.

14. The head-mountable display device of claim 11, wherein:
the first cable extends through the first pulley, through the central post, and couples to the second optical module; and
the second cable extends through the second pulley, through the central post, and couples to the second optical module.

15. The head-mountable display device of claim 14, wherein the interpupillary distance adjustment mechanism is disposed near an upper portion of the frame.

16. The head-mountable display device of claim 11, wherein the first pulley and the second pulley each comprises a pair of pulleys configured to vary a height of the cable as the cable loops through the pair of pulleys of the first pulley and the pair of pulleys of the second pulley.

17. The head-mountable display device of claim 14, wherein the first pulley is angled relative to the second pulley to vary a height of the cable as the cable loops through the first pulley and the second pulley.

18. The head-mountable display device of claim 11, wherein the interpupillary distance adjustment mechanism further comprises a tensioning pulley configured to limit creep of the first cable.

19. A head-mountable display device, comprising:
a frame;
a display coupled to the frame, the display comprising a first optical module and a second optical module; and
an interpupillary distance adjustment mechanism configured to adjust a distance between the first optical module and the second optical module, the interpupillary distance adjustment mechanism comprising:
a first leadscrew coupled to the first optical module;
a second leadscrew coupled to the second optical module and disposed at an angle relative to the first leadscrew;
a center joint connecting the first leadscrew and the second leadscrew;
wherein a rotation of the first leadscrew adjusts the interpupillary distance between the first optical module and the second optical module.

20. The head-mountable display device of claim 19, wherein the adjustment of the first leadscrew simultaneously adjusts a position of the first optical module and the second optical module.
